(19) United States
(12) Patent Application Publication
(10) Pub. No.: US 2008/0280488 A1
(43) Pub. Date: Nov. 13, 2008

(54) Modular electrical connector for a circuit board

(76) Inventor: James T. Hartley, Tustin, CA (US)

Correspondence Address: DELPHI TECHNOLOGIES, INC., M/C 480-410-202, PO BOX 5052, TROY, MI, 48007, US

(21) Appl. No.: 11/801,389

(22) Filed: May 9, 2007

(51) Int. Cl. H01R 13/66

(52) U.S. Cl. 439/567; 439/60

(57) ABSTRACT

An electrical connector assembly comprising a plurality of electrical connectors arranged side-by-side and including at least partially superimposed mounting flanges.

### BACKGROUND OF THE INVENTION

This invention relates generally to electrical connectors and, more particularly, to electrical connectors for circuit boards.

Mating circuit board connectors typically include plug connectors mounted to an edge of a daughtercard, and socket connectors mounted to a surface of a motherboard. Custom-designed circuit board connectors include a multitude of different types of specialized contacts and varying mounting footprints, are relatively expensive, require long lead times to design and manufacture, and have unique mounting footprints that present product packaging problems. Rows of side-by-side standard connectors occupy much space on circuit boards, are difficult to precisely align to traces on an underlying circuit board, and also have varying mounting footprints.

### SUMMARY OF THE INVENTION

In one aspect, this invention provides an electrical connector assembly comprising a plurality of electrical connectors arranged side-by-side and including at least partially superimposed mounting flanges. Accordingly, the invention may provide a relatively high density connector assembly. Additionally, the connectors may be provided according to integer multiples of a given mounting footprint so as to standardize the assembly. Also, fasteners may be provided through all of the mounting flanges for good alignment with traces on an underlying circuit board. Moreover, the assembly may include two or more different types of connectors, such as fiber optic, coaxial, digital, differential pair, or radio frequency connectors.

### BRIEF DESCRIPTION OF THE DRAWINGS

FIG. 1 is an exploded plan view of an exemplary implementation of an electrical connector assembly;

FIG. 2 is an exploded perspective view of the electrical connector assembly of FIG. 1;

FIG. 3 is a plan view of the electrical connector assembly of FIG. 1 in an assembled state;

FIG. 4 is front view of an exemplary implementation of an edge-mount electrical connector assembly; and

FIG. 5 is a front view of an exemplary implementation of a surface-mount electrical connector assembly.

### DETAILED DESCRIPTION OF THE PREFERRED EMBODIMENTS

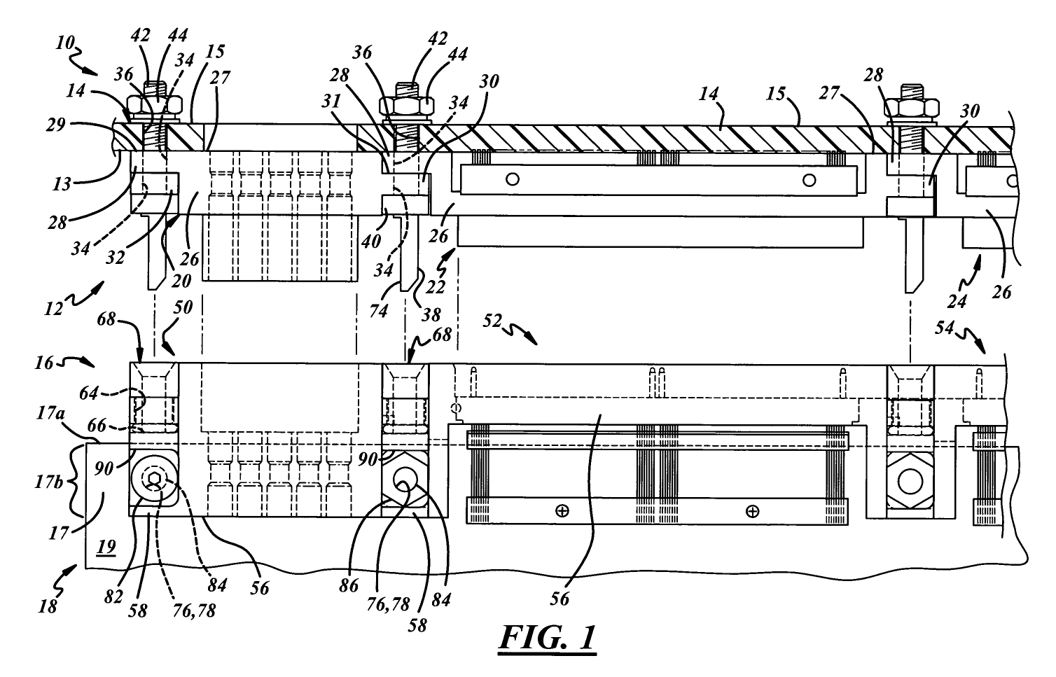

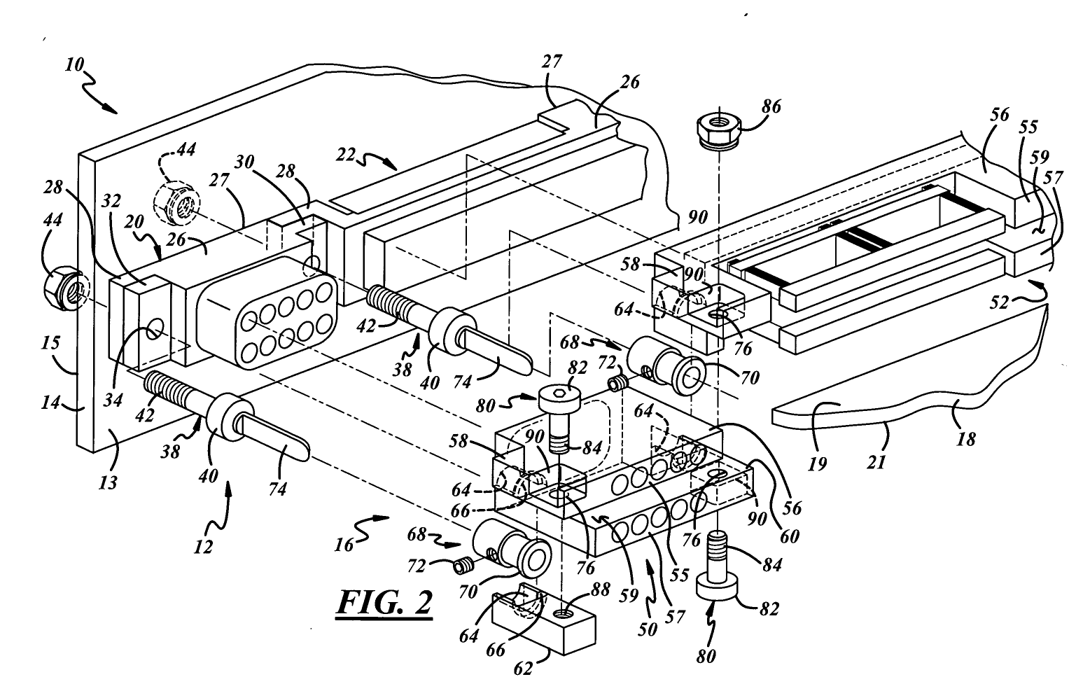

Referring now to the drawings, FIGS. 1 and 2 illustrate one exemplary implementation of an electrical connection apparatus 10 for connecting circuit boards to one another. The apparatus 10 includes a row of surface-mount electrical connectors 12 mountable to a first circuit board 14 such as a backplane, fixed board, motherboard, or the like, and a row of edge-mount electrical connectors 16 mountable to a second circuit board 18 such as a free board, daughtercard, or the like. The connectors 12, 16 may include mating plug and/or socket types of connectors. In any case, the connectors 12, 16 are configured for engagement with one another.

Referring to FIGS. 1 and 2, the row of surface-mount connectors 12 include a plurality of individual surface-mount connectors in a side-by-side, partially superimposed arrangement carried on a first surface 13 of the first circuit board 14. The row of surface-mount connectors 12 include a first surface-mount connector 20, a second surface-mount connector 22 adjacent and partially superimposed on the first surface-mount connector 20, and may include a third surface-mount connector 24 adjacent and partially superimposed on the second surface-mount connector 22.

The surface-mount connectors 20, 22, 24 include bodies 26 having circuit board mounting surfaces 27, first mounting flanges 28 extending laterally from sides of the bodies 26 and being substantially flush with the first surface 13 of the first circuit board 14, and second mounting flanges 30 extending laterally from opposite sides of the bodies 26 generally opposite the first mounting flanges 28 and being spaced from the first surface 13 of the first circuit board 14. The bodies 26 may be adapted to carry any electrical terminals or the like (not shown) in any suitable fashion.

The mounting flanges 28, 20 of the adjacent connectors 20, 22, 24 are at least partially superimposed. As used herein, the terminology superimposed mounting flanges includes at least portions of mounting flanges that are overlapping one another along a direction normal to the surface 13 of the circuit board 14. In other words, adjacent connectors 20, 22, 24 are at least partially shingled or laid over one another at their mounting flanges 20, 28.

The connectors 20, 22, 24 may be mounted to the circuit board 14 in any suitable fashion, such as using polarizing hardware. At sides of the row of connectors 12 having only one mounting flange, mounting blocks 32 may be provided in place of a mounting flange of an adjacent connector to help fasten the plurality of connectors to the circuit board 14. The flanges 28, 30 and blocks 32 include mounting holes 34 that are aligned with corresponding mounting holes 36 of the circuit board 14. Polarizing fasteners such as fastening pins 38 are inserted through the mounting holes 34, 36 from one side of the circuit board 14 such that shoulders 40 of the pins 38 trap the superimposed flanges 28, 30 and/or blocks 32 to the circuit board 14, and threaded ends 42 of the pins 38 extend beyond a second surface 15 of the circuit board 14. Fasteners, such as nuts 44, are threaded to the threaded ends 42 of the pins 38 to fasten the connectors 20, 22, 24 and/or blocks 32 to the circuit board 14. Accordingly, the polarizing fastening pins 38 and nuts 44 serve as fastening hardware and, as will be described below, polarizing hardware.

Still referring to FIGS. 1 and 2, the row of edge-mount connectors 16 include a plurality of individual edge-mount connectors in a side-by-side, partially superimposed arrangement carried by an edge 17 of the second circuit board 18. The edge 17 may include an end surface 17a and a margin 17b adjacent the end surface 17a on either side of the circuit board 18. The row of edge-mount connectors 16 may include a first edge-mount connector 50, a second edge-mount connector 52 adjacent and partially superimposed on the first edge-mount connector 50, and a third edge-mount connector 54 adjacent and partially superimposed on the second edge-mount connector 52.

The edge-mount connectors 50, 52, 54 include bodies 56, first flanges 58 extending laterally from sides of the bodies 56 and being substantially flush with a front surface 19 of the second circuit board 18, and second flanges 60 extending laterally from opposite sides of the bodies 56 generally opposite the first flanges 58 and being substantially flush with a rear surface 21 of the second circuit board 18. The bodies 56 include opposed flanges 55, 57 and a channel 59 therebetween. The flanges 55, 57 are adapted to mount against the front and rear surfaces 19, 21, respectively, of the circuit board 18, wherein the channel 59 is adapted to accept the edge 17 of the circuit board 18 therein. The bodies 56 may be adapted to carry any electrical terminals or the like (not shown) in any suitable fashion. One of the mounting flanges 58 or 60 is disposed on one side of the channel 59, and the other 58 or 60 is disposed on another side of the channel 59. The mounting flanges 58, 60 of the adjacent connectors 50, 52, 54 are at least partially superimposed.

The connectors 50, 52, 54 may be mounted to the circuit board 18 in any suitable fashion. At sides of the row of connectors 16 having only one mounting flange, mounting blocks 62 may be provided to help fasten the connectors 16 to the circuit board 18. The flanges 58, 60 and blocks 62 include semi-cylindrical pockets 64 including semi-annular grooves 66. The pockets 64 receive polarizing guide sockets 68 that include annular projections 70 that fit within the semi-annular grooves 66 of the pockets 64 to axially retain the sockets 68 to their respective flanges 58, 60 and/or blocks 62. The polarizing guide sockets 68 also include set screws 72 extending transversely therein.

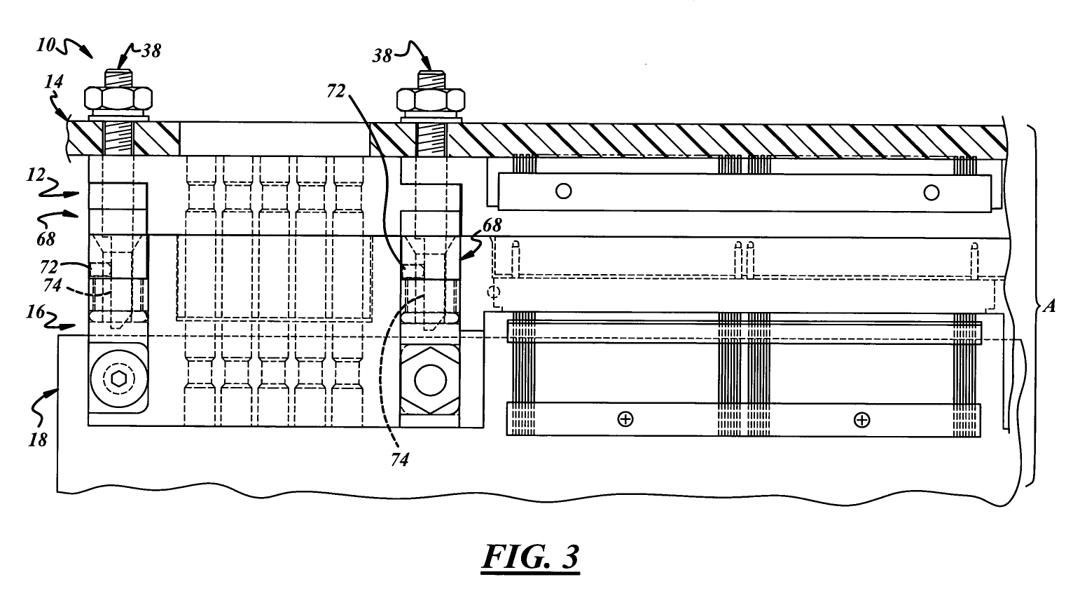

In FIG. 3, a circuit board assembly A includes the first connectors 12 and board 14 assembled to the second connectors 16 and board 18. As shown, the sockets 68 receive the polarizing fastening pins 38 when the pins 38 and sockets 68 are circumferentially aligned, or polarized, such that set screws 72 of the sockets 68 are normal to flats 74 of the pins 38. The polarizing hardware 38, 68 may be rotatable in increments of sixty degrees to provide six positions per pin 38 and socket 68 and, thus, thirty six positions per connector pair. The pins 38 and the sockets 68 may be rotationally fixed to their respective connectors 12, 16 and/or blocks 32, 62 in any suitable fashion such as using flats (not shown) therebetween or the like. Polarizing hardware is generally known to those skilled in the art, and any other type(s) of polarizing hardware and configuration may also or instead be used.

Referring to the connectors 16 in FIGS. 1 and 2, the flanges 58, 60 and blocks 62 include mounting holes 76 that are aligned with corresponding mounting holes 78 of the circuit board 18. Screws 80 including heads 82 and threaded ends 84 are inserted through the mounting holes 76, 78 from one side of the circuit board 18 beyond the other, and are threaded at the threaded ends 84 to nuts 86 or to fastening features such as threaded passages 88 in the blocks 62 to trap the flanges 58, 60 and blocks 62 to the circuit board 18. Reliefs 90 may be provided in the flanges 58, 60 to accommodate flush mounting of the fasteners 80, 86.

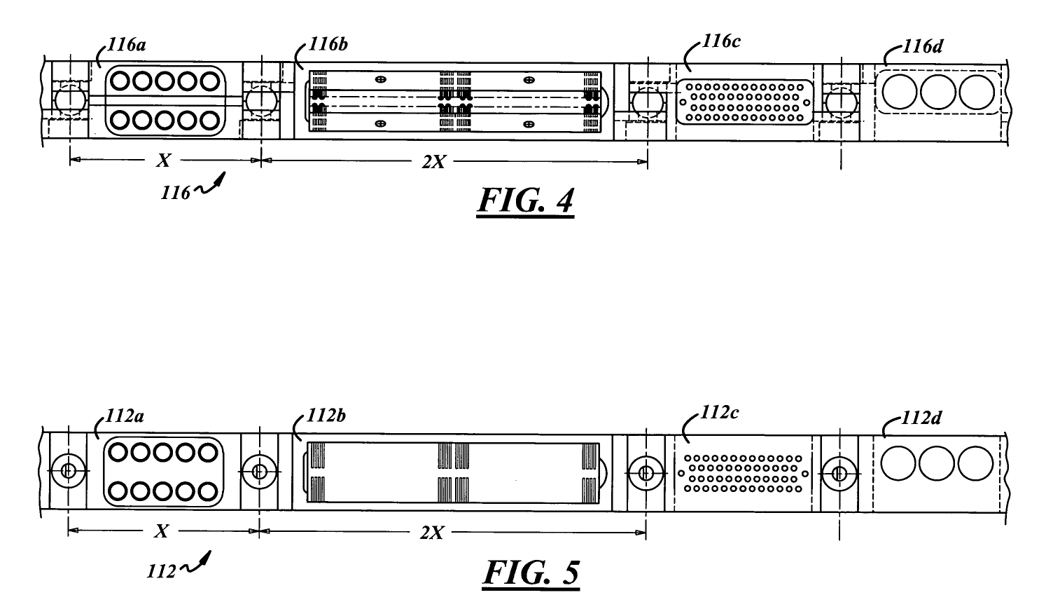

Referring now to FIGS. 4 and 5, any types of connectors may be used. For example, as shown in FIG. 4, a plurality of edge-mount connectors 116 may include a fiber optic or coaxial connector 116a, a digital connector 116b, a high speed differential pair connector 116c, a radio frequency size 8 connector 116d, and/or the like. Similarly, as shown in FIG. 5, a plurality of surface-mount connectors 112 may include a fiber optic or coaxial connector 112a, a digital connector 112b, a high speed or differential pair connector 112c, a radio frequency or size 8 connector 112d, and/or the like.

FIGS. 4 and 5 also illustrate that connectors may be provided in integer multiples of a given footprint X, which can be a standard footprint size or any other size, such as 1.300″, 1.500″, or any other suitable size. For example, the connectors 112a, 116a include the footprint X, and adjacent connectors 112b, 116b include a footprint 2X that is twice the size of the footprint X. The connectors 112, 116 could also be provided in any other multiples of the given footprint, such as three, four, or more times the size of the footprint X. Accordingly, the connector footprints X, 2X, etc. are standardized so as to render circuit board and connector designs more predictable, and to reduce complexity and cost of connector assemblies.

FIGS. 4 and 5 further illustrate that each of the connectors 112, 116 may be located to its respective circuit board on laterally opposed sides of each of the connectors 112, 116. This ensures that each interface or interconnection between each connector 112, 116 and its circuit board is precisely aligned. Accordingly, the connectors 112, 116 are precisely mounted to their respective circuit boards (not shown), yet are located relatively closely together in side-by-side fashion to yield a relatively small overall assembly mounting footprint and, thus, a relatively high density side-by-side connector arrangement.

It will be readily understood by those persons skilled in the art that the present invention is susceptible of broad utility and application. Many embodiments and adaptations of the present invention other than those described above, as well as many variations, modifications and equivalent arrangements, will be apparent from or reasonably suggested by the present invention and the foregoing description, without departing from the substance or scope of the present invention. Accordingly, while the present invention has been described herein in detail in relation to its preferred embodiment, is to be understood that this disclosure is only illustrative and exemplary of the present invention and is made merely for purposes of providing a full and enabling disclosure of the invention. The foregoing disclosure is not intended or to be construed to limit the present invention or otherwise to exclude any such other embodiments, adaptations, variations, modifications and equivalent arrangements, the present invention being limited only by the following claims and the equivalents thereof.

We claim:

1. An electrical connector assembly comprising a plurality of electrical connectors arranged side-by-side and including at least partially superimposed mounting flanges.

2. The assembly of claim 1, wherein the plurality of electrical connectors includes a plurality of edge-mount electrical connectors.

3. The assembly of claim 2, wherein at least one of the electrical connectors includes a body including opposed flanges and a laterally extending channel therebetween, and a pair of mounting flanges laterally extending from opposite sides of the body, wherein one of the mounting flanges is disposed on one side of the channel, and the other mounting flange is disposed on another side of the channel.

4. The assembly of claim 3, further comprising:
a mounting block having a pocket;
pockets in the mounting flanges; and
a polarizing socket carried between the mounting block and a corresponding one of the mounting flanges in the pockets of the corresponding mounting flange and the mounting block.

5. The assembly of claim 4, wherein the mounting block includes a fastening feature and the assembly further comprises a fastener extending through at least one of the mounting flanges and cooperating with the fastening feature of the mounting block to fasten the mounting block to its corresponding mounting flange.

6. The assembly of claim 3, further comprising:
pockets in the mounting flanges; and
polarizing sockets carried between the overlapping mounting flanges in the pockets.

7. The assembly of claim 1, wherein the plurality of electrical connectors include at least two of the following types of connectors: fiber optic; coaxial; digital; differential pair; or radio frequency.

8. The assembly of claim 1, wherein the plurality of electrical connectors includes a plurality of surface-mount electrical connectors.

9. The assembly of claim 8, wherein at least one of the plurality of connectors includes a body having a circuit board mounting surface, and a pair of mounting flanges extending from opposite sides of the body, wherein one of the mounting flanges is substantially flush with the circuit board mounting surface of the body, and the other mounting flange is spaced a distance away from the circuit board mounting surface of the housing.

10. The assembly of claim 9, further comprising a mounting block at least partially superimposed on one of the substantially flush mounting flanges, and a polarizing fastener extending through the substantially flush mounting flange and the mounting block.

11. The assembly of claim 10, further comprising a fastener coupled to the polarizing fastener to fasten the mounting flanges and mounting block together.

12. The assembly of claim 9, further comprising polarizing fasteners extending through the mounting flanges.

13. The assembly of claim 12, further comprising fasteners coupled to the polarizing fasteners to fasten the connectors to one another.

14. The assembly of claim 1, further comprising polarizing fasteners extending through the mounting flanges.

15. The assembly of claim 1, wherein the plurality of electrical connectors are provided in integer multiples of a given mounting footprint.

16. A circuit board assembly, comprising:
a first circuit board including a first surface;
a plurality of surface-mount connectors mounted to the first surface of the first circuit board, and including at least partially superimposed mounting flanges;
a first plurality of fasteners to fasten the superimposed mounting flanges to the first circuit board;
a second circuit board including an edge;
a plurality of edge-mount connectors mounted to the edge of the second circuit board for connecting to the plurality of surface-mount connectors, and including other at least partially superimposed mounting flanges; and
a second plurality of fasteners to mount the other superimposed mounting flanges to the second circuit board.

17. The circuit board assembly of claim 16, wherein at least one of the edge-mount connectors includes:
a body including opposed flanges mounted against opposite surfaces of the second circuit board and a laterally extending channel therebetween to receive the edge of the second circuit board, and
a pair of mounting flanges laterally extending from opposite sides of the body, wherein one of the mounting flanges is disposed on one side of the channel against one surface of the second circuit board, and the other mounting flange is disposed on another side of the channel against an opposite surface of the second circuit board.

18. The circuit board assembly of claim 16, wherein at least one of the surface-mount connectors includes:
a body having a circuit board mounting surface mounted against the first surface of the first circuit board, and
a pair of mounting flanges extending from opposite sides of the body, wherein one of the mounting flanges is substantially flush with the circuit board mounting surface of the body and mounted against the first surface of the first circuit board, and the other mounting flange is spaced a distance away from the circuit board mounting surface of the housing so as to define a gap between the other mounting flange and the first surface of the first circuit board.

19. An electrical connector for mounting to an edge of a circuit board, comprising:
a body including opposed flanges and a laterally extending channel therebetween; and
a pair of mounting flanges laterally extending from opposite sides of the body, wherein one of the mounting flanges is disposed on one side of the channel, and the other mounting flange is disposed on another side of the channel.

20. An electrical connector for mounting to a surface of a circuit board, comprising:
a body having a circuit board mounting surface; and
a pair of mounting flanges extending from opposite sides of the body, wherein one of the mounting flanges is substantially flush with the circuit board mounting surface of the body, and the other mounting flange is spaced a distance away from the circuit board mounting surface of the housing.
